(19) United States
(12) Patent Application Publication
(10) Pub. No.: US 2007/0032912 A1
(43) Pub. Date: Feb. 8, 2007

(54) Vehicle system

(76) Inventors: Clemens Jung, Hannover (DE); Heiko Freienstein, Weil der Stadt (DE)

Correspondence Address: KENYON & KENYON LLP, ONE BROADWAY, NEW YORK, NY, 10004, US

(21) Appl. No.: 10/567,506

(22) PCT Filed: Aug. 12, 2004
(86) PCT No.: PCT/EP04/51779

§ 371 Date: Jul. 12, 2006

(30) Foreign Application Priority Data
Aug. 18, 2003 (DE) 103 37 852.9

(51) Int. Cl. G06F 7/00

(52) U.S. Cl. 701/1; 701/36

(57) ABSTRACT

A vehicle system for operation in a motor vehicle has an operator control for operating the vehicle system and a controller for influencing operation of the vehicle system via the operator control. The vehicle system also includes a device which is designed for determining whether the operator control is being accessed by the driver or another occupant of the vehicle, and the controller influences the operation of the vehicle system via the operator control at least as a function of whether the operator control is being accessed by the driver or another occupant of the vehicle. In this manner, operator access which may excessively distract the vehicle driver from the actual driving task is thus effectively disabled. At the same time, the vehicle system remains fully, or at least largely, operational for other vehicle occupants.

### FIELD OF THE INVENTION

The present invention relates to a vehicle system, e.g., a vehicle navigation system, for operation in a motor vehicle.

### BACKGROUND INFORMATION

Conventional vehicle navigation systems output driving directions for guiding a vehicle driver along a previously computed route to a destination in acoustic and/or visual form. To compute the travel route, the driver must input the destination via an operator interface of the vehicle navigation system. Since inputting the destination while driving causes considerable distraction from the traffic situation, it has been discussed to suppress the operation of the device, in particular destination input, while the vehicle is in motion (referred to hereinafter as the “speed lock function”).

Published German patent document DE 199 52 857 describes a device for controlling vehicle components as a function of the driver's condition, in which the driver's condition is determined and the information to be displayed is filtered as a function thereof. Operation and control by the driver is thus improved and safety is enhanced because the driver is less distracted. This device limits the operation of a functionality of the electronic device as a function of the situation. For example, the destination input of a navigation device may not be used or a TV set may not be turned on during travel. Full use or partial functionality of an application of the electronic device may also be turned on or off as a function of the speed of travel.

German patent application 102 55 435.8 (not a prior publication) describes a driver information system having an operator control in which operation at a certain detected speed of the vehicle is at least limited, i.e., having the above-described speed lock function; however, this limitation may be at least partially cancelled if, for example, occupancy of the front-seat passenger seat has been determined by a seat belt fastener sensor or a weight sensor. This approach assumes that, in the case of an occupied front-seat passenger seat, the front-seat passenger actually operates the driver information system; however, operation by the vehicle driver is not ruled out. In practice, it has been found that, even if the front-seat passenger seat is occupied, the vehicle driver often assumes operation of the device.

### SUMMARY

The vehicle system according to the present invention has the advantage over the prior art that operation of the system is influenced depending on whether the vehicle driver or another occupant of the vehicle is accessing the vehicle system. Operating access which may excessively distract the vehicle driver from the actual driving task is thus effectively disabled. At the same time, the vehicle system remains fully, or at least largely, operational for other vehicle occupants. Operation is understood in the context of the present invention primarily as inputs by the operator into the vehicle system, but also as outputs of the vehicle system to the user.

In the case of a navigation system, for example, the front-seat passenger may thus assume operation of the navigation system while the vehicle is in motion. Operation during travel may be necessary, for example, if the travel route is modified manually due to traffic problems not taken into account when the route was computed, or due to errors in the navigation data material.

When a front-seat passenger is present, additional inputs are thus possible and unnecessary stops are avoided, which contributes to safety. The present invention provides for dynamically limiting operation, which limiting functionality goes beyond that of the conventional speed lock function in the case of attempted operating access by the vehicle driver while the vehicle is in motion.

In each case, the present invention increases user acceptance of the speed lock function.

### BRIEF DESCRIPTION OF THE DRAWINGS

FIG. 1 shows a block diagram of an example embodiment of the vehicle system according to the present invention.

FIG. 2 shows a flow chart illustrating a software program executed in a controller of the vehicle system according to the present invention.

### DETAILED DESCRIPTION

The vehicle system according to the present invention is described in detail below using the example of a vehicle navigation system. This, however, does not mean that the present invention is limited to vehicle navigation systems. Rather, the present invention is also applicable to other vehicle systems, e.g., car radios or a cell phone operated in a vehicle.

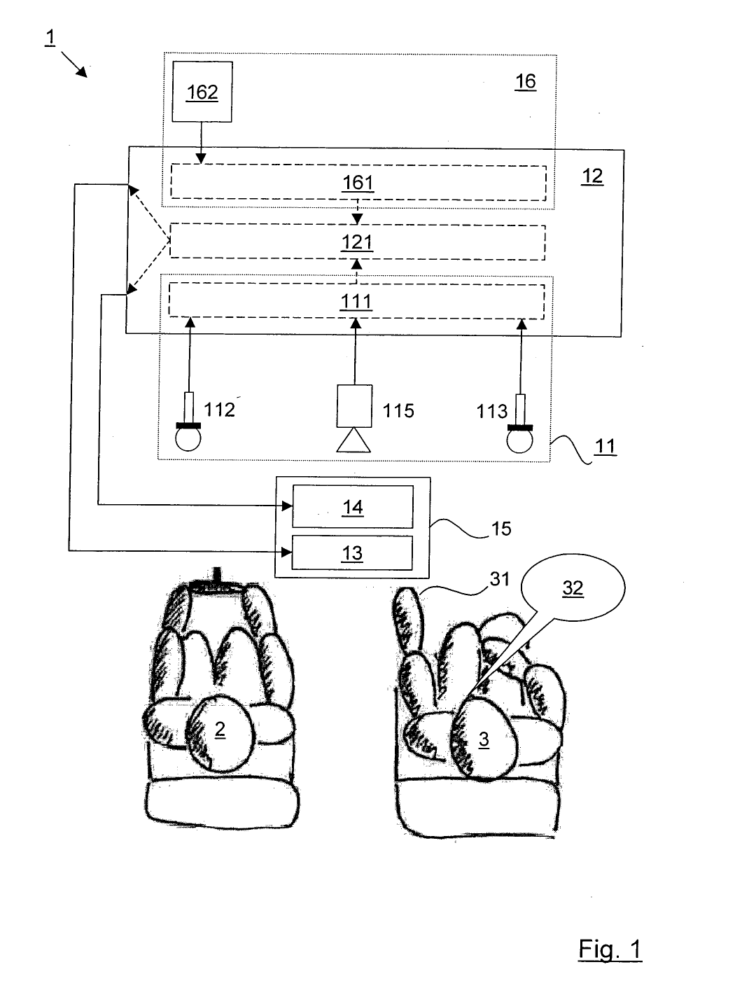

Vehicle system 1 according to the present invention, as shown in FIG. 1, includes an input device 13 having control elements not depicted in detail in the figure, e.g., momentary-contact switches and/or incremental rotary transducers, for inputting commands and/or operating parameters into vehicle system 1. In the case of a vehicle navigation system, the above-described control elements, combined for example with a controller 12 of the navigation system, are used for inputting a destination for a subsequent route computation from the current location to the destination and subsequent navigation. In the case of a cell phone, the control elements are used, for example, for dialing a certain telephone number of a desired conversation partner or for answering an incoming telephone call.

Vehicle navigation system 1 according to the present invention also includes an output device 14, which may be designed as a visual and/or acoustic output. In the case of a vehicle navigation system, output device 14, combined with the navigation device, is used for outputting driving directions to guide the vehicle driver in the form of spoken driving directions and/or directional arrows displayed on a display device. Alternatively or additionally, a map display may be provided, on which the computed route or a portion thereof is displayed to orient the driver.

p Furthermore, output device 14 combined with the destination input may be used, for example, for displaying selectable destinations and/or a map display, on which a destination may be marked with the aid of a cursor operable via the control elements of input device 13.

In the case of a car radio, output device 14 includes, for example, the display of the car radio which, in addition to the name or the receiving frequency of a currently set broadcast station, displays variable information transmitted using the radio data system (RDS), such as title and performer of a song currently being transmitted or running text such as advertising.

Input device 13 and output device 14, both connected to controller 12, together form an operator control 15 of the vehicle system according to the present invention.

Means 11, designed for detecting whether the driver or another vehicle occupant is accessing operator control 15 of vehicle system 11, is also connected to controller 12 of the vehicle system according to the present invention and generates an appropriate access detection signal as a function of the person accessing the system.

For this purpose, access detection means 11 includes sensors for detecting information, on the basis of which it is possible to determine which of the vehicle occupants is accessing operator control 15 for operating vehicle system 1.

In a first example embodiment of the operator detection means, this sensor system includes a camera 115, whose imaging range includes at least driver seat (2) or the front-seat passenger seat (3), but may include both the driver and the front-seat passenger seats. The image information recorded by the camera is processed in a first software module ill of controller 12 and a signal is derived therefrom, which indicates whether driver 2 or front-seat passenger 3 is accessing operator control 15, e.g., the control elements of input device 13.

The exact mode of operation of first software module 111 for determining which one of the vehicle occupants is accessing the system is not described in more detail. The principle involved is abundantly known from the literature. Reference is made to the overview article, D. M. Gavrila: “The Visual Analysis of Human Movement: A Survey” in Computer Vision and Image Understanding, vol. 73, no. 1, January, pp. 82-98, 1999, in which approaches to this problem regarding driver or front-seat passenger detection are described.

An image pattern comparison, for example, is suitable for this purpose, an image previously recorded and stored as part of the software component, for example, of the hand or also the arm and possibly the upper body of the front-seat passenger accessing the system being used as a basis for the comparison. Alternatively, three-dimensional or other image detection algorithms may also be used.

In the context of the present invention, it is only essential that first software component 111 is capable of using the image signals of camera 115 to unambiguously determine whether the hand of driver 2 or hand 31 of front-seat passenger 3 is accessing the control elements of input device 13 of vehicle system 1.

According to an advantageous variant of this first example embodiment of access detection means 11, instead of a single camera 115, at least two video sensors are provided at a distance from one another or a multicamera video sensor is provided. The stereo or multichannel image information detected by this sensor system allows three-dimensional detection of the driver or front-seat passenger seat, or the driver or front-seat passenger.

According to the first example embodiment, the gray scale value information contained in the video signals is also analyzed for the purpose of access detection 11.

According to another advantageous variant of this first example embodiment, access determination means (11) operates by the principle of depth sensors, which in the present case of a video sensor system are based on the principle of structured lighting.

Both the evaluation of stereo or multichannel video information and the principle of structured lighting are described in detail in the related art, for example, in X. Jiang, Three-dimensional Computer Viewing, Springer-Verlag, Berlin Heidelberg.

A second example embodiment of operator detection device 11 is based on the assumption that vehicle system 1 is at least partly, in particular with respect to its more complex operating functions, operated via spoken commands. At least one microphone 112 is required to detect the spoken commands. The microphone is situated within a hands-free device for a cell phone, e.g., in front of the driver seat in or on the vehicle dashboard. At least one second microphone 113 which is installed spatially separated from first microphone 112, e.g., in front of the front-seat passenger seat in the dashboard of the motor vehicle, is provided for detecting whether the verbal commands have been given by vehicle driver 2 or front-seat passenger 3. The signals of both the first and second microphone are supplied to first software component 111 of controller 12, which uses the difference in propagation time between the signals of the first and second microphone, for example, via cross-correlation of the two microphone signals, to determine whether driver 2 or front-seat passenger 3 has issued the verbal commands. This is made possible by the above-described location of microphones 112 and 113, because, for example, the commands issued by vehicle driver 2 to second microphone 113 need a longer propagation time than those issued to first microphone 112 situated in front of the driver. The same is true for the commands issued by front-seat passenger 3.

Additional example embodiments of access detection means 11 may also include a radar sensor system, and a sensor system which operates and evaluates signals on the basis of a depth sensor by the propagation time principle or the laser scanner principle.

These alternative measuring and evaluation methods are also abundantly known from the related art, for example, from R. Schwarte et al., “New Powerful Sensory Tool in Automotive Safety Systems Based an PMD-Technology,” Advanced Microsystems for Automotive Applications 2000, Springer-Verlag, Berlin Heidelberg, 2000.

According to a first example embodiment of the operation control, the operation, i.e., operability of vehicle system 1 is controlled on the basis of the detected operator, e.g., driver 2 or other occupant 3 of the vehicle. For this purpose, controller 12 includes a second software component, which further processes the signal of operator detection means 11 and controls operator control 15, in particular the scope of its functions, on the basis thereof. The control of the operation of vehicle system 1 includes in particular limiting or enabling of operation functionalities as a function of the vehicle occupant operating the system. The vehicle driver may thus only have access to a limited operator interface, i.e., a limited scope of functions 13 and a limited selection of functions of operator guidance 14, while front-seat passenger 3 may access the entire range of operations of vehicle system 1.

According to an example embodiment of the present invention, additional means 16 is provided in controller 12 of vehicle system 1 for generating at least one signal indicating the motion status, e.g., motion as opposed to a standstill, of the motor vehicle. This may be a tacho signal generator 162, which generates a signal indicating the instantaneous vehicle velocity. In the case of a vehicle navigation system 1, means 16 may also include a GPS receiver, which analyzes position data about the instantaneous vehicle position and derives a signal indicating the instantaneous motion status of the vehicle.

The signals indicating the motion status of the vehicle, for example, the signals of tacho signal generator 162, are supplied to an analyzer 163, which may be designed as a component of the controller in the form of a third software routine. Analyzer 162 is designed to use the signals indicating the motion status of the vehicle to determine whether the vehicle is at a standstill, is moving, or is moving at a certain minimum velocity.

Signal generator 162 and analyzer 161 form a device 16 for detecting motion of the vehicle.

According to a second example embodiment of the operating control, which is based on the embodiment of the vehicle system having motion detection device 16, the operation of vehicle system 1 is controlled as a function of both the vehicle's motion status and detected operator 2 or 3 of vehicle system 1.

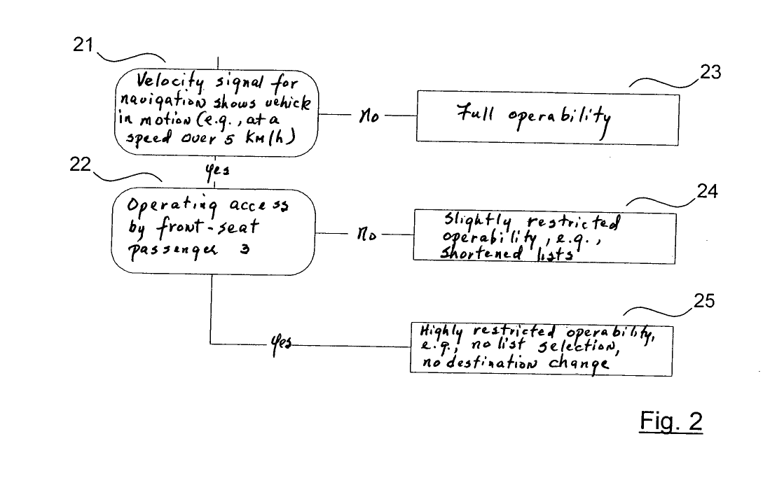

This is explained below using the example of a vehicle navigation system in a motor vehicle, taking into account the flow chart of FIG. 2.

A distinction is made between three states.

1. Vehicle at a standstill:

On the basis of the motion data acquired by sensor system 162, motion detection means 16 detects that the vehicle is at a standstill (step 21—alternative “no”). For this case, controller 12 enables operation of the full range of vehicle navigation system 1 (step 23). This means that, for example, a destination, i.e., the name of the destination in particular and a corresponding street name, may be input via control elements of input device 13 of the navigation system, inputting being supported by navigation system 1 via appropriate displays, for example, of proposed names, on display device 14, on the basis of input letters.

2. Vehicle in motion, operating access by driver 2:

Motion detection means 16 uses the motion data detected by sensor system 162 to determine that the vehicle is in motion (step 21, alternative “yes”). Furthermore, the access detection means detects that the vehicle driver is accessing operator control 15 (step 22, alternative “yes”), i.e., the hand of driver 2 is in the area of input device 2 of vehicle navigation system 1, and a control element of vehicle navigation system 1 is being actuated. Alternatively, this access status may also be identified by the fact that a control element of input device 13 is operated and hand 31 of the front-seat passenger is not in the area of input device 13 of the vehicle navigation system.

In this case, controller 12 controls the functions of navigation system 1 in such a way that it restricts or simplifies the outputs directed at the vehicle driver by output device 14 to maximally reduce the distraction of vehicle driver 2 from the traffic situation. In the present example of the vehicle navigation system, for example, a map display having a route drawn in is replaced while the vehicle is in motion by the display of simple and easy-to-grasp turn arrows and by a simple verbal turn direction. Thus, in particular, complex directions such as “please turn left onto Hilderheimer Strasse in 500 m, please reduce speed, sharp curve” are replaced by shorter and easier-to-grasp directions such as “left now” or “next street on the left.” Furthermore, controller 12 completely locks input device 13 of operator control 15 for inputs by driver 2, i.e., it implements the speed lock function as defined above (step 25).

3. Vehicle in motion, operating access by front-seat passenger 3:

Motion detection means 16 detects motion of the vehicle on the basis of the motion data detected by sensor system 162 (step 21, alternative “yes”). Furthermore, access detection means 11 determines that front-seat passenger 3 is accessing operator control 15 (step 22, alternative “no”), i.e., hand 31 of front-seat passenger 3 is in the area of input device 13 of vehicle navigation system 1, and a control element of vehicle navigation system 1 is being actuated. Alternatively, this access status may also be identified by the fact that a control element of input device 13 is being actuated and the hand of driver 2 is not in the area of input device 13 of vehicle navigation system 1.

For this case, controller 12 allows at least a limited or, depending on the embodiment of the present invention, even full operability of vehicle system 1 (step 24). In this case, i.e., with the vehicle in motion and operating access by front-seat passenger 3, controller 12 enables all display possibilities and input procedures which are also enabled with the vehicle at a standstill, because these may be performed by front-seat passenger 3, who does not have to concentrate on driving the vehicle. However, the outputs intended primarily directly for the vehicle driver engaged in the task of driving are output in a simple and therefore easy-to-grasp form as described previously.

Alternatively (step 24), the acoustic driving directions of navigation system 1 may also be output in an easy-to-grasp, abbreviated form here, whereas a detailed map with the route of travel drawn in appears on the display of the vehicle navigation system, so that it is able to be understood by the front-seat passenger, who then may impart explanatory or additional directions to the vehicle driver. Furthermore, this alternative allows the front-seat passenger to better understand and, if necessary, to correct the route.

Furthermore, the range of operability for operating access by front-seat passenger 3 with the vehicle in motion may be individually settable.

When separate output and/or input devices are available to the driver and the front-seat passenger, as is the case of individual entertainment systems for the backseat passengers, or when an additional display device is available, for example, in a combo instrument in addition to the display of the vehicle system provided in the center console, additional operating strategies may be advantageously provided. Thus, in the case of a vehicle in motion and operating access by front-seat passenger 3, simple directional arrows may be displayed, for example, to driver 2 by the additional display in the combo instrument for navigation, while a detailed map with the route drawn in is made available to the front-seat passenger on the display in the center console display or front seat head support. Furthermore, operation by front-seat passenger 3 may be enabled by allowing the front-seat passenger to set any desired map detail or zoom factor via the input device, while only the directional arrows continue to be displayed to driver 2.

Controller 12 thus achieves motion-dependent and operator-dependent control of the operation of vehicle system 1 by operator control 15.

1-10. (canceled)

11. A vehicle system for operation in a motor vehicle, comprising:
an operator control for operating the vehicle system;
a controller unit operatively connected to the operator control, wherein the control unit influences operation of the vehicle system requested by the operator control; and
an access detection device for determining which one of vehicle occupants is accessing the operator control, the vehicle occupants including at least one of a driver and a passive passenger;
wherein the controller unit influences operation of the vehicle system requested by the operator control at least depending on which one of vehicle occupants is accessing the operator control.

12. The vehicle system as recited in claim 11, further comprising:
a motion detection device for determining a motion status of the motor vehicle, wherein the controller unit influences operation of the vehicle system requested by the operator control additionally as a function of a detected motion status of the vehicle.

13. The vehicle system as recited in claim 11, wherein the controller unit limits at least some operations of the vehicle system requested by the operator control if it is determined that the vehicle is in motion and the operator control is being accessed by the vehicle driver.

14. The vehicle system as recited in claim 13, wherein the access detection device includes a video sensor system having an image-detection range that includes at least a driver seat and a front-seat passenger seat.

15. The vehicle system as recited in claim 14, wherein the access detection device includes one of a stereo and multi-camera video sensor.

16. The vehicle system as recited in claim 15, wherein the access detection device takes into consideration the gray-scale value information contained in detected signals, in determining which one of the vehicle occupants is accessing the operator control.

17. The vehicle system as recited in claim 13, wherein the access detection device includes a radar sensor device.

18. The vehicle system as recited in claim 13, wherein the access detection device includes at least one depth sensor which utilizes the propagation time principle for detection.

19. The vehicle system as recited in claim 13, wherein the access detection device includes at least one depth sensor which utilizes the laser scanner principle for detection.

20. The vehicle system as recited in claim 13, wherein the access detection device includes at least one depth sensor which utilizes the structured lighting principle for detection.
